(19) United States
(12) Patent Application Publication
(10) Pub. No.: US 2002/0024413 A1
(43) Pub. Date: Feb. 28, 2002

(54) Metrhod of manufacturing a substantially closed core, core, and magnetic coil

(76) Inventors: Martinus Johannes Maria De Graaf, Eindhoven (NL); Oscar Perez Cornejo, Alcala de Henares (ES); Ruediger Mauczok, Erkelenz (DE)

Correspondence Address: U.S. Philips Corporation, 580 White Plains Road, Tarrytown, NY, 10591, US

(21) Appl. No.: 09/935,895

(22) Filed: Aug. 23, 2001

(30) Foreign Application Priority Data
Aug. 24, 2000 (EP) 00202940.3

(51) Int. Cl. H01F 27/24; H01F 3/00; B29C 31/00

(52) U.S. Cl. 336/213; 29/604; 264/267

(57) ABSTRACT

A core (1) for use in a magnetic coil with a filled first gap (2) is realized through the provision of the first gap (2), filling of the first gap (2) with a curable synthetic resin (3), and curing of said resin (3). After curing, the synthetic resin is substantially homogeneously distributed over the first gap (2) and has a concave surface (17). The synthetic resin (3) may contain a filler, which preferably substantially consists of a magnetic material.

The invention relates to a method of manufacturing a geometrically substantially closed ring-shaped core provided with a first gap which is substantially filled, which core has an inner face defining an inner circumference, an outer face defining an outer circumference, and two substantially parallel side faces, and is suitable for use in a magnetic coil.

The invention also relates to a ring-shaped core which is substantially closed and provided with a first gap, which first gap is substantially filled with a spacer material, which core has an inner face defining an inner circumference, an outer face defining an outer circumference, and two substantially parallel side faces, and is suitable for use in a magnetic coil.

The invention further relates to a magnetic coil comprising a core and a number of turns.

Such a core and such a method are known from an article ‘The Micro-Gapped Toroid, A New Magnetic Component’ by Brian Wiese and George Schaller from Ceramic Magnetics Inc, published at www.cmi-ferrite.com. Said core—also referred to hereinafter as gapped core to distinguish it from the not yet gapped, closed core—is also commercially available. In the known method, a closed core is cut into two half cores, which are subsequently glued together with a spacer material to create two gaps. The known gapped core therefore has two gaps, which together enclose an angle of 180°. The core has an outer diameter in the range of 3.4 to 12.5 mm. As follows from an analysis of the known gapped core, the spacer material is a foil with a top and a bottom face. The two halves are glued on the foil, which implies that an adhesive is present on both faces. After assembly of the two halves on the foil, superfluous parts of the foil are cut away. The gaps are then filled with and the foil material and adhesive.

A disadvantage of the known method is that the two half cores must be assembled into the gapped core. This assembly is expensive.

It is a first object of the invention to provide a method of the kind described in the opening paragraph in which no assembly of two half cores is necessary.

It is a second object of the invention to provide a core of the kind described in the opening paragraphs, which can be manufactured in a cost-effective way.

The first object is achieved in that the method comprises the consecutive steps of providing the first gap in the core, filling of the first gap by dispensing a curable synthetic resin, and curing said curable synthetic resin.

In the method of the invention the spacer material of the first gap is not a foil but the synthetic resin, which is a viscous polymeric liquid. Hence, it can be dispensed easily. This liquid is subsequently cured, which may be done, for example, thermally or optically with ultraviolet irradiation. Examples of curable synthetic resins are polyepoxides and polyacrylates, among others. After curing the synthetic resin has a good adhesion to the core, which is manifest from a concave surface of the synthetic resin.

In the method of the invention, an assembly of two halves of the core is not necessary. After the curable synthetic resin in the first gap has been cured, a second gap can be provided. Said second gap may be filled with a curable synthetic resin as well. Further gaps may also be provided.

The provision of the gap may be done in various ways known in the art, such as laser cutting and sawing with a diamond saw. Dispensing of the synthetic resin is preferably done by using a dispenser provided with a positioning system. Such a dispenser is commercially available and known from the field of component placement machines. The method is especially, but not exclusively, suitable for small cores, i.e. cores having an outer diameter of less than 25 mm and having a gap width of less than 1.5 mm. The core preferably comprises a ferrite material.

In an embodiment of the method of the invention, the core is put on a carrier having a surface before the provision of the first gap, such that the core rests with the outer face on the surface of the carrier. This embodiment of the method is very suitable for the provision of the first gap in the core. A large number of cores placed in a coaxial arrangement, can be processed—i.e. provision and filling of the first gap—in one batch, with as the sawing or cutting and dispensing apparatus for the process being is shifted coaxially. Parallel rows of coaxially placed cores may also be processed simultaneously using an apparatus with several cutting and dispensing means. This increates the manufacturing capacity substantially. The embodiment further has the advantage that a large number of cores can be placed on the same carrier on a relatively small surface area.

In another embodiment of the method of the invention the core is attached to a carrier having a surface before the provision of the first gap, such that the core rests with said first major face on the surface of the carrier. The core is kept with at least one attachment means in its position on the surface of the carrier during the provision and the filling of the first gap. In practice a large number of cores is processed simultaneously. These cores can be advantageously placed on the carrier. To the attachment means keep the cores keep in their positions on the carrier, and—once provided—the first gaps in the cores keep their positions on the carrier. Therefore, the filling of the first gaps is simplified.

The attachment means may be chemical in character, e.g. a droplet of adhesive on the surface of the carrier or on the flat face of the core before the attachment of the core to the carrier. The attachment means may alternatively be mechanical in character, for example a notch, a score in the surface of the carrier or one or more protrusions of the surface of said carrier. The attachment means could even be electromechanical, for example through the provision of an electromagnetic field from a source—e.g. a magnet—in or under the carrier.

In a further embodiment of the method of the invention a second gap is provided substantially simultaneously with the provision of the first gap, which first and second gap together enclose an angle of substantially 180°. If a number of cores are attached to the carrier and positioned in a line, it is easy to provide not only the first gap, but also the second gap in each of the cores; e.g. by cutting or sawing along a line. Especially if the first and the second gap are provided simultaneously, it is crucial that the attachment means should keep the core—and thus the two halves of the core—and the gaps of the core in position on the surface of the carrier. It is advantageous to manufacture a core provided with a first and with a second gap; in comparison with a similar core with a first gap only, the fringing flux, and hence the electrical losses, are reduced considerably. Of course further gaps may be provided after the first and a second gap have been made.

It is an advantage of the method of the invention that the synthetic resin can be mixed with a filler before dispensing into the gap. Said filler can be used to adapt the properties of the spacer material in the gap, such as the magnetic permeability or the viscosity. In the known core, by contrast, the spacer material cannot be filled owing to the presence of the foil. Preferably, the filler is a magnetic material. In this case the magnetic properties of the core can be adapted in an efficient way: a large number of cores with standardized dimensions and standardized gap widths can be produced, after which the magnetic properties are fine-tuned through variation of the magnetic material and the concentration of the magnetic material present as a filler.

The object to provide a core which can be manufactured in a cost-effective way is achieved in that the spacer material is a synthetic resin which is substantially homogeneously distributed in the first gap and has a concave surface. As a result of the method of the invention, the core of the invention can be manufactured in a cost-effective way. An advantage of the core of the invention is that its mechanical stability is good, also if more than one gap is present or if the core has an outer diameter of about 4 mm or a thickness of the order of a millimeter. The core preferably contains a ferrite material. A gapped ferrite core has low losses, can have a small outer diameter, and has a good resistance to DC saturation effects. A gapped ferrite core is therefore very well suited for use in applications with a switching frequency up to the MHz range. Cores are preferably toroidal, but they may be rectangular as well, in which case the inner and outer faces are formed by several constituent faces. Their outer diameter is preferably in the range of 2 to 20 mm, and more preferably in the range of 3.4 to 12.5 mm.

In an embodiment of the core of the invention, the synthetic resin is mixed with a filler. Said filler may be any kind of solid material, such as alumina, silica, a glass, particles. An advantage of a synthetic resin mixed with a filler is that shrinkage of the synthetic resin, which takes place on curing, is limited to less than 0.5 per cent, in general 0.1-0.3 per cent. Preferably, the filler contains particles which have a mean diameter of 5-50 μm. A preferred concentration of the filler is 0.1-60% by volume with respect to the curable synthetic resin.

In a further embodiment of the core of the invention, the filler is a magnetic material. Examples of magnetic materials are ferrites such as MnZn, NiZn, MgZn and iron-containing particles. The synthetic resin mixed with a magnetic filler has a greater magnetic permeability than an unfilled synthetic resin or air. The presence of the synthetic resin mixed with a magnetic filler therefore has a number of advantages. For example, any gapped toroidal core has a fringing flux which causes electrical losses. The higher magnetic permeability reduces the fringing flux around the gap. Another advantage is that the core of the invention can have a gap width which is larger than the gap width of a similar core having the same inner and outer diameters and having the same magnetic properties. For example, the gap width is increased from 75 to 200 μgm, if the ratio of the magnetic permeabilities of the filled and the unfilled synthetic resin is about 2.7. A gap with a gap width of 200 μm can be manufactured more easily than a gap width of 75 μm. Besides, the tolerance in the gap width of 200 μm is greater, thus providing a higher yield. Furthermore a gap having a gap width of 200 μm can be replaced by two gaps each having a gap width of 100 μm. By contrast, a gap width of 35 μm comes close to a technological limit for sawing or cutting.

A further advantage of the core having a first gap filled with a synthetic resin containing a magnetic filler is that the properties of the core can be fine-tuned through variation of the concentration and the kind of magnetic filler. At the same time, cores with fine-tuned magnetic properties can be produced in a cost-effective manner; cores can be produced with standardized dimensions and standardized gap widths. For example, the presence of a magnetic filler provides the opportunity in a core to have a gap with a gap width of 200 μm, which has the same magnetic permeability as an unfilled gap with a gap width of 10 μm.

The core of the invention can be used very well in a magnetic coil of the kind described in the opening paragraph. Said coil could be used very well in applications such as power management circuits, power invertors, signal inductors with a DC component, linear inductors, and high frequency temperature stable devices.

While the invention has been described in terms of some preferred embodiments, those skilled in the art will recognize that the invention may be implemented with modifications within the spirit and scope of the appended claims.

These and other aspects of the core and of the method of the invention will be further explained by means of the figures, of which:

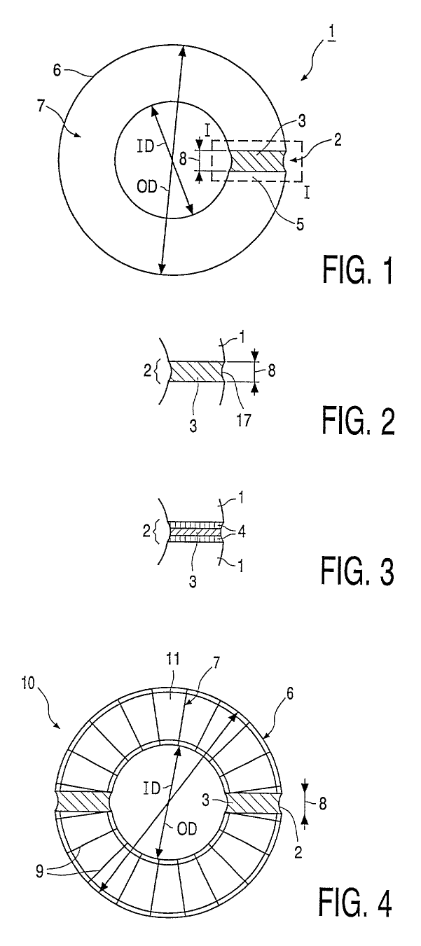

FIG. 1 is a diagrammatic plan view of a coil with a core with a single gap according to the invention;

FIG. 2 is a diagrammatic cross-sectional/ view of the filled gap in the core, which is an enlarged detail of FIG. 1 as indicated by the square I-I therein;

FIG. 3 is a diagrammatic cross-sectional/ view of a similar cross section in detail as in FIG. 2, but for the gapped core according to the prior art;

FIG. 4 is a diagrammatic perspective view of the core with two gaps according to the invention;

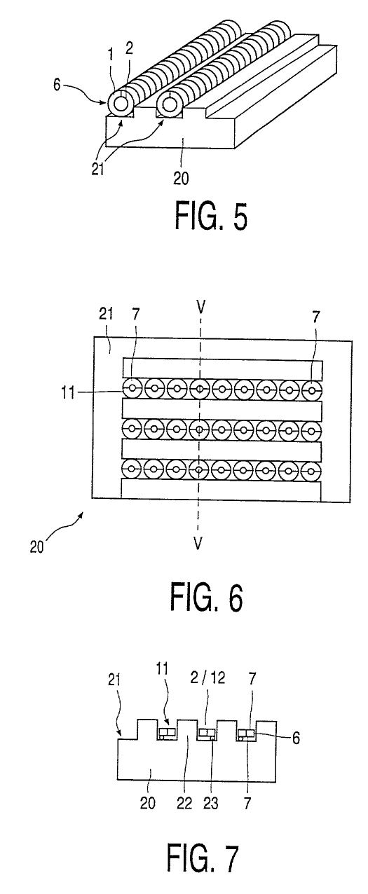

FIG. 5 is a diagrammatic cross-sectional perspective view of a carrier on which a number of cores are present;

FIG. 6 is a diagrammatic cross-sectional/ view of a plan view of another carrier on which a number of cores are present; and

FIG. 7 is a diagrammatic cross-sectional/ view of a cross-section of said carrier along the line V-V in FIG. 6.

The toroidal core 1 in FIG. 1 has an inner face 5 defining an inner diameter ID, an outer face 6 defining an outer diameter OD, and two substantially parallel side faces 7. A first gap 2 is present in the toroidal core 1, which first gap 2 has a gap width 8. The first gap 2 is filled with a spacer material 3, which is a synthetic resin. The synthetic resin is substantially homogeneously distributed over the first gap and has a concave surface 17, as is shown in FIG. 2. The core 1 is geometrically substantially closed owing to the synthetic resin 3 in the first gap 2. If the core 1 is used in a coil, then turns of the coil cannot leave the core 1.

The first gap 2 of the toroidal core 1 of the prior art is shown in FIG. 3. In the first gap 2 a spacer material 3 is present, which is a foil. An adhesive 4 is present for connecting the foil 3 to the core 1. Therefore, the spacer material 3 in the core 1 of the prior art is not substantially homogeneously distributed, nor has it a concave surface.

The coil 10 in FIG. 4 comprises a toroidal core 11 and is provided with a number of turns 9. The toroidal core 11 has an outer diameter OD, an inner diameter ID, a first gap 2 and a second gap 12. The first gap 2 and the second gap 12 together enclose an angle of substantially 180 degrees. The first gap 2 and the second gap 12 each have a gap width 8. The core 11 has a has a first major face 5, a second major face 6, a channel 15 running from the first 5 to the second major face 6, and a circumferential side face 7.

FIG. 5 shows a carrier 20 on which a number of toroidal cores 1 are placed. The carrier 20 has a surface 21. The toroidal cores 1 are attached such that the cores 1 rest with their outer faces 6 on the surface 21 of the carrier 20. First gaps 2 are provided in said cores 1 by cutting or sawing said first gaps 2 are subsequently filled with a curable synthetic resin by means of a dispenser apparatus. After curing of the curable synthetic resin, second gaps can be provided in the cores 1. This is advantageously done by rotating the cores 1 with respect to the carrier 20 in a plane perpendicular to the carrier 20.

FIG. 6 schematically shows that a number of toroidal cores 11 is attached to the surface 21 of a carrier 20 by one of their side faces 7. This is done before any gaps 2, 12 are provided in the cores 11. FIG. 7 schematically shows that the cores 11 are kept in their positions on the surface 21 by attachment means 22, 23. The attachment means 22 is a protrusion which keeps the cores 11 in their positions mechanically. The attachment means 23 is a droplet of adhesive with which the cores 11 are kept in their positions chemically. While the cores are being kept in their positions, first gaps 2 and preferably also second gaps 12 can be provided in the cores 11 and filled with a curable synthetic resin. The choice of attachment means 22, 23 is free so as to allow alternative embodiments. Given a suitable design of the protrusions 22, a third and a fourth gap may be provided and filled after a rotation of the carrier through 90 degrees with respect to sawing and dispensing apparatus not shown. Said rotation is to be done in the plane of the surface 21 of the carrier 20.

### EXAMPLE 1

A MnZn-ferrite based toroidal core 1 with OD=4.5 mm, ID=2.3 mm and height=1.4 mm has a first gap 2 with a gap width 8 of 50 μm. The core 1 has a permeability value of 2000, so that an inductance of 45.10⁻⁹ H/n² is generated when the core 1 is used in a magnetic coil 10. In this said expression, n is the number of turns 9. The first gap 2 is provided by sawing with a diamond blade. The first gap 2 is filled with a UV-curable, adhesive synthetic resin without any inorganic filling material. The synthetic resin has a viscosity of 200 mPa.s. Initial curing is achieved by UV spot exposure at an intensity of 2000 mW/cm² during 2 seconds. The optimum thermal properties of the synthetic resin are achieved in a post-curing step. The core 1 is completely coated with an organic material in order to fulfill insulation requirements for toroidal cores 1.

### EXAMPLE 2

Before filling of the first gap 2, the UV-curable, adhesive synthetic resin is mixed with a filler. The filler substantially consists of MnZn-based ferrite particles with a size of 10-30 μm. The synthetic resin is mixed with the filler at a filler concentration of 65% by weight. The filled synthetic resin has a viscosity of 1500 mPa.s. The filled synthetic resin has a permeability of about 10.

A first gap 2 is provided in the MnZn-ferrite based toroidal core 1 with an OD of 4.5 mm, an ID of 2.3 mm and a height of 1.4 mm. The first gap 2 has a gap width of 370 μm. The gap is filled with the filled synthetic resin by dispensing. Subsequently, the gap is initially cured by UV-spot exposure followed by thermal curing for 3 minutes at 150-200° C. The core 1 is completely coated with an organic material in order to fulfill insulation requirements for toroidal cores 1. When applied in a magnetic coil 10, the core 1 provided with a first gap 2 filled with a synthetic resin mixed with ferrite particles has an inductance of 30.10⁻⁹ H/n², in which n is the number of turns 9.

### EXAMPLE 3

A MnZn-ferrite based toroidal core 11 has an OD of 9.4 mm, an ID of 5.1 mm and a height of 2.6 mm. The core 11 has a first gap 2 and a second gap 12, each of which gaps has a gap width 8 of 200 μm. The core 11 has a permeability of 2000, which generates an inductance of 25.10⁻⁹ H/n² is generated, when the core 11 is applied in a magnetic coil 10. In the said expression n is the number of turns 9. The first gap 2 and the second gap 12 together enclose an angle of substantially 180 degrees. The core 11 is manufactured by clamping of the core 11 with its flat face 6 on the surface 21 of a carrier 20, followed by sawing with a diamond blade, dispensing of a UV-curable synthetic resin in the first gap 2 and the second gap 12, and curing. The synthetic resin has a viscosity of 600 mPa.s, after being mixed with a filler of Al₂O₃ in a concentration of about 40% by weight. In this way the original gap size dimensions are maintained. Initial curing is done by a UV spot exposure at an intensity of 2000 mW/cm² during 2 seconds. The optimum thermal properties of the adhesive are achieved in a post-curing step. The core 1 is completely coated with an organic material in order to fulfill insulation requirements for toroidal cores 1.

1. A method of manufacturing a geometrically substantially closed ring-shaped core (1) provided with a first gap (2) which is substantially filled, which core (1) has an inner face (5) defining an inner circumference, an outer face (6) defining an outer circumference and two substantially parallel side faces (7), and is suitable for use in a magnetic coil (10), which method comprises the following consecutive steps:
providing the first gap (2) in the core (1),
filling the first gap (2) by dispensing a curable synthetic resin, and
curing said curable synthetic resin.

2. A method as claimed in claim 1, characterized in that before the provision of the first gap (2) the core (1) is put on a carrier (20) having a surface (21), such that the core (1) rests with said outer face (6) on the surface (21) of the carrier (20).

3. A method as claimed in claim 1, characterized in that
before the provision of the first gap (2) the core (1, 11) is attached to a carrier (20) having a surface (21), such that the core (1) rests with one of its side faces (7) on the surface (21) of the carrier (20), and
the core (1) is kept with at least one attachment means (22; 23) in its position on the surface (21) of the carrier (20) during the provision and the filling of the first gap (2).

4. A method as claimed in claim 3, characterized in that substantially simultaneously with the provision of the first gap (2) a second gap (12) is provided, which second gap (12) is diametrically opposed to the first gap (2).

5. A method as claimed in claim 1, 2 or 3, characterized in that a filler is added to the synthetic resin before the curable synthetic resin is dispensed.

6. A ring-shaped core (1, 11) which is substantially closed and provided with a first gap (2), which first gap (2) is substantially filled with a spacer material, which core (1, 11) has an inner face (5) defining an inner circumference, an outer face (6) defining an outer circumference, and two substantially parallel side faces (7), and is suitable for use in a magnetic coil (10), characterized in that the spacer material is a synthetic resin (3) which is substantially homogeneously distributed in the first gap (2) and has a concave surface (17).

7. A core (1, 11) as claimed in claim 6, characterized in that the synthetic resin comprises a filler.

8. A core (1, 11) as claimed in claim 7, characterized in that the filler is a magnetic material.

9. A core (1, 11) as claimed in claim 6 or 8, characterized in the core (1, 11) comprises a second gap (12), and in that the first (2) and the second gap (12) enclose an angle between 5 and 355° with one another.

10. A magnetic coil (10) comprising a core (1, 11) as claimed in claim 6 and a number of turns (9).
